(19) United States
(12) Patent Application Publication
(10) Pub. No.: US 2010/0191586 A1
(43) Pub. Date: Jul. 29, 2010

(54) Providing Cashback Offers

(75) Inventors: Jithendra K. Veeramachaneni, Sammamish, WA (US); Michael J. Miles, Duvall, WA (US); Brandon C. Adams, Auburn, WA (US); Milan Lathia, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/360,426

(22) Filed: Jan. 27, 2009

(51) Int. Cl. G06Q 30/00; G06F 7/06; G06F 17/30

(52) U.S. Cl. 705/14.1; 707/E17.108

(57) ABSTRACT

Methods, systems, and computer-readable media for providing one or more cashback offers are disclosed. A search query entered by a user into a search engine is obtained. The search query is utilized to determine that cashback offers in association with the search query exist. Upon a determination that cashback offers exist, a cashback notification is provided that indicates to a user that cashback offers are available. In embodiments, the cashback notification is displayed in association with one or more search results corresponding with the search query.

### BACKGROUND

Many consumers utilize a web search engine to locate a product or service of interest such that the user can purchase the product or service. Accordingly, a user enters a search query into a web search engine to obtain a set of search results. The user then navigates through the search results to find a product or service being sold at a desired price. Oftentimes, however, the user is unaware of any cashback, rebates, coupons, or other incentives associated with the desired product or service. As such, the user misses an opportunity to receive a reward, such as a monetary payment, for purchasing a product or service associated with a cashback opportunity.

### SUMMARY

Embodiments of the present invention generally relate to providing cashback offers. A cashback offer refers to an offer to provide a reward, such as a rebate, coupon, incentive, or a monetary payment, to a user if the user performs an activity, such as purchasing a product or service. A query is utilized to determine if cashback offers associated with the search query exist. In cases where a cashback offer associated with a user's search query exists, a cashback notification is displayed to provide a user with notification that cashback offers exist that might be of interest to the user. In some cases, a cashback notification is provided if the user demonstrates commercial intent (e.g., the user intends or is interested in purchasing a product or service). The user might be able to select the displayed cashback notification to indicate a desire to view the cashback offers. Upon selection of the cashback notification, cashback offers that are deemed to be associated with the user search query are displayed to the user.

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary cashback tool according to an embodiment of the present invention;

FIG. 3 is a flow diagram depicting a method for providing a cashback notification, according to an embodiment of the present invention;

FIG. 4 is a flow diagram depicting a method for providing one or more cashback offers, according to an embodiment of the present invention;

FIG. 5 is an illustration of a web browser window depicting a cashback notification, according to an embodiment of the present invention; and

FIGS. 6A-F are illustrations depicting several visual representations of a cashback notification in accordance with embodiments of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide methods, systems, and computer-readable media for providing one or more cashback offers to a user. In one aspect, a computer-implemented method for providing cashback offers is described. The method includes obtaining a search query entered by a user into a search engine and using the search query to determine that cashback offers in association with the search query exist. The method further includes providing a cashback notification that provides an indication that cashback offers are available, wherein the cashback notification is displayed in association with search results corresponding with the search query.

In another aspect, a computerized system for providing cashback offers is described. The system includes a query obtaining component that obtains a search query entered into a search engine, and an offer determining component that determines that one or more cashback offers in association with the search query exist. A notifying component provides a cashback notification that provides an indication that cashback offers are available. The cashback notification is displayed in association with one or more search results that correspond with the search query. A receiving component receives an input from a user indicating a desire to view the available cashback offers, and a presenting component displays the available cashback offers.

In yet another aspect, computer readable media having computer-executable instructions embodied thereon, that when executed, perform a method for providing cashback offers is disclosed. The method includes obtaining a search query at a search engine that provides both cashback search results and non-cashback search results via a search results webpage. Cashback offers in association with the search query are determined to exist by comparing search query terms of the search query with a set of cashback offers or information associated therewith. The identity of a link selected by a user is obtained. The link is displayed on the search results webpage. The search query terms are compared with the identity of the selected link or information associated therewith to determine that the user has a commercial intent. A cashback notification is displayed to the user via a toolbar upon the determination that cashback offers in association with the search query exist and the determination that the user has commercial intent. The cashback notification provides an indication that one or more cashback offers are available. A user-selection of the cashback notification is received and the available cashback offers are presented on a display.

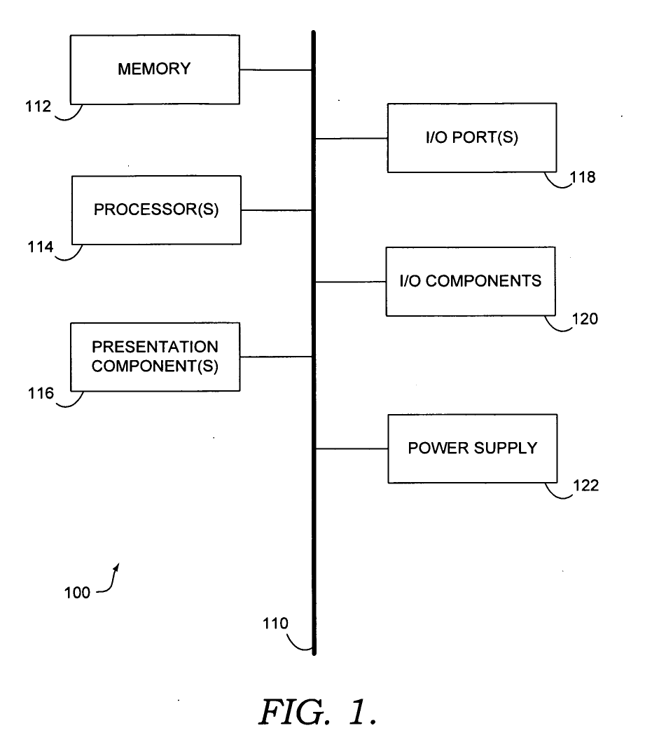

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing the present invention is shown and designated generally as computing device 100. The computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

With reference to FIG. 1, the computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. It is recognized that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. By way of example, and not limitation, computer-readable media may comprises random access memory (RAM); read only memory (ROM); electronically erasable programmable read-only memory (EEPROM); flash memory or other memory technologies; compact disc read-only memory (CD-ROM), digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

The memory 112 includes computer-storage media in the form of volatile and/or nonvolatile memory. The memory 112 may be removable, non-removable, or a combination thereof. Exemplary hardware devices include solid-state memory, hard drives, optical-disc drives, etc. The computing device 100 includes one or more processors that read data from various entities such as the memory 112 or I/O components 120. Presentation component(s) 116 present data indications to a user or other device. Exemplary presentation components 116 include a display device, speaker, printing component, vibrating component, etc.

I/O ports 118 allow the computing device 100 to be logically coupled to other devices including I/O components 120, some of which may be built in. Illustrative components include a microphone, joystick, game pad, satellite dish, scanner, printer, wireless device, etc.

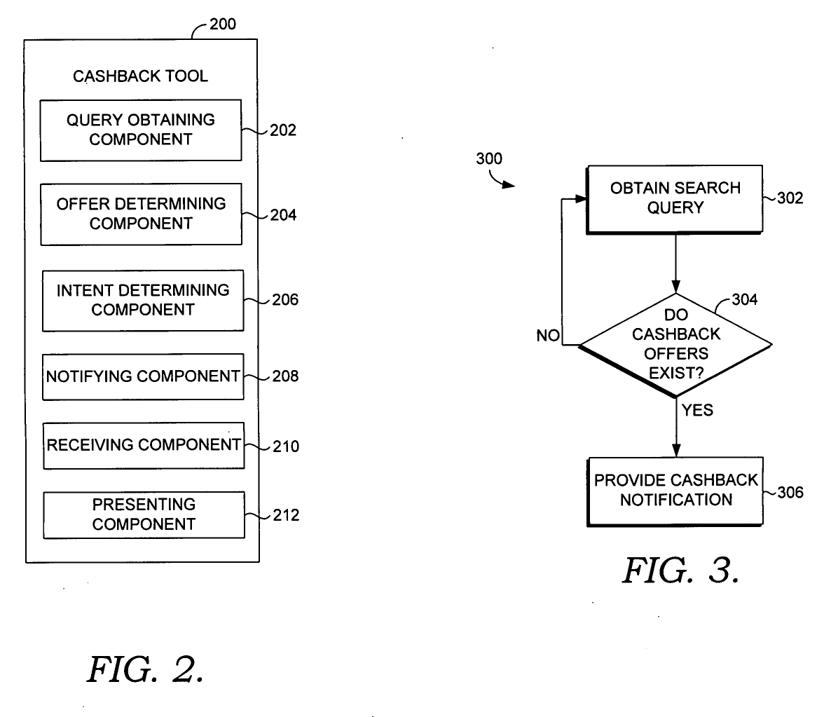

Referring now to FIG. 2 a block diagram is provided illustrating a cashback tool 200 used to provide cashback offers, in accordance with an embodiment of the present invention. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As previously mentioned, embodiments of the present invention relate to systems and methods for providing cashback offers. A cashback offer, as used herein, refers to an offer to provide a reward to a user for performing an incentivized activity. In embodiments, a reward may include a rebate, a coupon, a monetary payment, or other incentives. That is, a cashback offer provides offer details regarding a reward a user can receive for performing an incentivized activity. An incentivized activity refers to any activity that, if performed by a user, results in a reward being provided to the user. An incentivized activity might include, without limitation, a purchase, a trial (e.g., free trial), a request for information of a product and/or service, or the like. In embodiments, an incentivized activity refers to an online activity. In this regard, a purchase, trial, or request for information of a product and/or service occurs via a user performing the activity online (e.g., via the Internet).

Generally, a reward may be described as a percentage of a purchase price of an item that is returned to the consumer after performance of an incentivized activity, such as purchase of the item. In embodiments, the reward may be provided to a user at the time of purchase. Often, the monetary reward is placed in an earnings or other user account. In such a case, the consumer may withdraw the monetary reward, or a portion thereof, at any time. Alternatively, the consumer may only be allowed to withdraw the monetary reward, or a portion thereof, upon reaching a threshold amount of earnings. One skilled in the art will appreciate that a cashback offer might include any type of reward including, for example, a monetary payment, a monetary credit, a bank transfer, a gift voucher, a gift card, a coupon, a rebate, or any other benefit or incentive that rewards a user for performing an incentivized activity.

As shown in FIG. 2, the cashback tool 200 includes a query obtaining component 202, an offer determining component 204, an intent determining component 206, a notifying component 208, a receiving component 210, and a presenting component 212. In some embodiments, one or more of the illustrated components 202, 204, 206, 208, 210, and 212 may be implemented as stand-alone applications on a user device and/or a server in communication therewith. In other embodiments, one or more of the illustrated components 202, 204, 206, 208, 210, and 212 may be integrated into the operating system of a user device and/or a server in communication therewith or integrated with a web browser, or a toolbar associated therewith, of a user device. Such a user device and a server can communicate with one another via a network that includes, without limitation, one or more local area networks (LANs) and/or wide area networks (WANs). Such networking environments are commonplace in offices, enterprise-wide computing networks, intranets, and the Internet. A user device and/or a server in communication therewith may comprise any type of computing device, such as, for example, computing device 100 described above with reference to FIG. 1.

It will be understood by those of ordinary skill in the art that the components 202, 204, 206, 208, 210, and 212 illustrated in FIG. 2 are exemplary in nature and in number and should not be construed as limiting. Any number of components may be employed to achieve the desired functionality within the scope of embodiments of the present invention. In addition, one skilled in the art will appreciate that any number of components 202, 204, 206, 208, 210, and 212 can be implemented on a user device and/or a server connected therewith via one or more networks. For example, each of the components 202, 204, 206, 208, 210, and 212 may be downloaded to, installed on, or stored in memory of a user device or a server, such as computing device 100 of FIG. 1. Alternatively, one or more components of the cashback tool 200 may be located on a user device while one or more other components of the cashback tool 200 may be located at one or more networked servers, among other configurations. In embodiments, the cashback tool 200 may be a toolbar tool that functions as add-on software to an existing web browser software.

The query obtaining component 202 functions to obtain search queries, or portions thereof (e.g., search terms or search phrases). The query obtaining component 202 might receive, retrieve, reference, or intercept a query, or a portion thereof. In one embodiment, a query is a search query. A search query might be entered by a user into a search engine via a search engine webpage. Such a search engine might be any information retrieval system used to locate information within a computer system (e.g., the World Wide Web or other computer system) and provide search results. As such, in one embodiment, a search engine might be a web search engine that may search the World Wide Web generally based on a user's search query. Such a web search engine may provide search results related to any variety of products, services, information, data, or other information available on the World Wide Web. In this regard, a web search engine provides search results via a search engine webpage that are based generally on the user search query. For example, based on a user search query input into a general search website (e.g., Microsoft's Live.com), a general search engine (Microsoft® Live Search) searches for and provides general search results related to the search query. That is, the search engine results include at least one non-cashback search result and, in some instances, at least one cashback search result. As used herein, a cashback search result refers to a search result corresponding with a cashback offer. A non-cashback search result refers to a search result that does not correspond with a cashback offer, such as a search result having information related to a product or service or a search result including a sale of a product or service where no cashback offer is available.

One skilled in the art will appreciate that a user can interact with a search engine in any variety of ways. A user might interact with a search engine in a webpage format. That is, a search engine webpage might be utilized to enter a search query and provide search results. Exemplary search engine and corresponding webpages include, but are not limited to, Microsoft® Live Search accessible via Microsoft's Live.com and MSN.com web portal, Google™ search accessible through Google's google.com web portal, and Yahoo! search accessible through Yahoo's yahoo.com web portal. Alternatively, a user might interact with a search engine in a toolbar format in which a search query entry field is placed on a user's web browser for easier access to the search engine. In embodiments, the query obtaining component 202 obtains a search query, or a portion thereof, such that search engine functionality is not disrupted.

In another embodiment, a query is a system generated query. That is, a query is generated by a computing system, or a portion thereof. The system generated query may comprise a system call that provides a background process for searching for available cashback offers while a user's search query is parsed to the World Wide Web by a search engine, as described above.

The offer determining component 204 is configured to determine if one or more cashback offers in association with the query, or portion thereof, exist. In embodiments, the offer determining component 204 utilizes a search query, or a portion thereof, such as a search query obtained by query obtaining component 202, to determine if one or more cashback offers in association with the search query or search terms exist.

To determine if cashback offers exist, the offer determining component 204 may compare one or more search terms of a user's search query to one or more cashback offers or items or information associated therewith, for example, contained within one or more databases (e.g., a cashback database). In another embodiment, the offer determining component 204 makes a system call to determine if a cashback offer exists. In such a case, to determine if cashback offers exist, the offer determining component 204 might compare a system generated query, or a portion thereof, to one or more cashback offers or items of information associated therewith. Items of information associated with a cashback offer may include, for example, an indication of a cashback offer, a product and/or service associated with the cashback offer, and the like. In cases where at least a portion of a query corresponds, correlates, or matches with cashback offers or items of information associated therewith, the offer determining component 204 may determine that a cashback offer in association with the query (e.g. user search query or system generated query) exists. Such databases may be stored and maintained at a user device or at a server in communication therewith. One skilled in the art will appreciate that the offer determining component 204 might use a lookup system or an algorithm to determine if one or more cashback offers in association with the search query, or a portion thereof, exist.

The degree to which a query is required to correlate or match with cashback offers, or items of information associated therewith, can vary. For example, an exact word match between the search terms and items provided in a cashback offers database might be required to make a determination that a cashback offer in association with a query exists. Alternatively, a broader subject matter correlation may be utilized to conclude that a cashback offer exists, among other correlation methods. The degree to which a query correlates or matches items might be established by a developer or a user of the cashback tool 200, or a portion thereof.

Alternatively or additionally, to determine if cashback offers in association with a query exist, the offer determining component 204 might perform a search. A search might be performed to identify websites associated with a cashback offer, such as, for example, websites associated with a seller, retailer, or the like having products or services for sale in association with a cashback offer. In one embodiment, a search might be performed by the offer determining component 204 or another component (e.g., another component associated with the cashback tool 200). Alternatively, a search might be performed via a cashback search engine. In such a case, the query, or portion thereof, entered by the user into a general search engine can be communicated to a cashback search engine for performing a search therein for cashback offers. A cashback search engine is dedicated to searching for and presenting search results that relate to items associated with a cashback offer. That is, a cashback search engine is dedicated to providing search result that correspond with a cashback offer.

By way of example only, the query obtaining component 202 obtains a search query, or a portion thereof, and the offer determining component 204 employs a cashback search engine to perform a search for cashback offers associated with the obtained search query. The search is performed in the background without direct knowledge by a user. Based on the results of the search, the offer determining component 204 determines if cashback offers exist. In embodiments, the offer determining component 204 determines existence of a cashback offer such that search engine functionality is not disrupted.

The intent determining component 206 is configured to determine if commercial intent exists. That is, the intent determining component 206 can determine if search activities performed by users indicate commercial intent. Commercial intent exists when it appears that a user has an interest in or intention to perform a desired incentivised activity, such as an interest in purchasing a product or service. In this regard, demonstrating an interest or intention to perform a desired incentivised activity increases the likelihood that a user will appreciate and take advantage of a cashback offer. The intent determining component 206 can determine the existence of commercial intent such that search engine functionality is not disrupted.

In embodiments, the intent determining component 206 determines whether a commercial intent exists based on an analysis of a search query, a link selection, or a combination thereof. In using a search query, or a portion thereof, the intent determining component 206 might identify whether a commercial intent indicator is presented within the search query. A commercial intent indicator provides an indication that a user has, or might have, an interest in or intention to perform a desired incentivised activity, such as purchase a product and/or service. A commercial intent indicator might include, for example, an indication of a product or service, a price, an intention to purchase or otherwise make use of, or any other keyword that might indicate commercial intent of a user. Such commercial intent indicators might be established by a developer or user of the cashback tool 200. One skilled in the art will appreciate that the intent determining component 204 might use a lookup system or an algorithm to determine if a commercial intent in association with a user exists.

In using a link selection, the intent determining component 206 might identify whether selection of a link indicates commercial intent. A selected link might be a link that a user selects from a search results webpage. Accordingly, the intent determining component 206, or another component, might be configured to obtain an identity of a link, and/or information associated therewith, selected by a user, such as via a search results webpage, among others. In one embodiment, a selected link indicates commercial intent in instances where the selected link is associated with a provider, seller, or promoter of a product or service. That is, if a user selects a link that results in a webpage associated with a provider, seller, or promoter of a product and/or service, the intent determining component 206 might recognize an indication or existence of commercial intent.

The intent determining component 206 might identify that a selected link is associated with a provider, seller, or promoter of an item using a lookup system. In this regard, link information (e.g., link title, link URL, link summary, or the like) associated with the selected link might be compared to a list of links (e.g., a list of commercial websites stored in a database) to identify if a selected link indicates commercial intent. Alternatively or additionally, the intent determining component 206 might analyze (e.g., search) the website in association with the selected link to identify if a commercial intent indicator is provided therein that indicates commercial intent of a user. Such a commercial intent indicator might include, for example, an indication of a product or service, a price, an offer for sale, or any other keyword that might indicate commercial intent of a user. Such commercial intent indicators might be established by a developer or user of the cashback tool 200. One skilled in the art will appreciate that commercial intent indicators associated with link selection analysis might be the same as or overlap with commercial intent indicators associated with query analysis. It can be appreciated that the analysis function of the intent determining component 208 may follow various approaches or combinations thereof, examples of which are given herein for illustration, but are in no way inclusive of all possible approaches.

With continued reference to FIG. 2, the notifying component 208 functions to present a cashback notification. A cashback notification can provide an indication to a user that a cashback offer is available. As such, a user can recognize that cashback offers are available that might be of interest to the user. In one embodiment, the notifying component 208 provides a notification when a cashback offer in association with a query exists, for example as determined by the offer determining component 204, and when commercial intent exists, for example as determined by the intent determining component 206. If a cashback offer in association with a query exists and the user is found to have commercial intent, then the notifying component 208 may display a cashback notification to notify the user that a cashback offer is available.

In an alternative embodiment, the notifying component 208 provides a cashback notification when one of a cashback offer exists or commercial intent exists. For example, a cashback notification might be displayed to a user in cases where the offer determining component 204 determines that cashback offers exist, even though commercial intent does not exist (e.g., the intent determining component 206 determines that commercial intent does not exist or the cashback tool does not determine commercial intent). Using the existence of commercial intent to provide a cashback notification prevents a notification from being displayed to a user when a user has, or demonstrates, no interest in performing an incentivized activity. Using the existence of cashback offers to provide a cashback notification prevents a notification from being displayed to a user when no cashback offers exist that are associated with a query, such as a search query entered by the user.

Because a cashback notification might be provided when cashback offers in association with a query and/or commercial intent exists, the notifying component 208 might be configured to recognize whether a notification should be provided. In embodiments, the notifying component 208 may receive, retrieve, reference, or obtain information from the offer determining component 204 (e.g., whether a cashback offer exists) and/or the intent determining component 206 (e.g., whether commercial intent exists) to identify whether to provide a cashback notification to a user. One skilled in the art will appreciate that the notifying component 208 might apply any number of thresholds to identify whether a notification should be provided. Such thresholds might include numerical thresholds, quality thresholds, or the like. That is, a cashback notification might be provided only if more than ten cashback offers in association with the search query exist, only if a certain level of commercial intent exists, etc.

By way of example only, assume that a presentation of a cashback notification is based on the existence of both a cashback offer and commercial intent. Further, assume that the notifying component 208 identifies an existence of a cashback offer and commercial intent. In such a case, the notifying component 208 can present a cashback notification via a display screen. On the other hand, assume that the notifying component 208 only identifies an existence of a cashback offer. In such a case, the notifying component 208 might not present a cashback notification to a user.

The cashback notification may comprise any visual feature, audio feature, or a combination thereof. Such a visual feature or display might include, but not limited to, flashing, blinking, color changing, text, or animating of objects on a display, among others. Audio features may include sounds, such as beeps, tones, clicks, horns, or music files, among others, as well as vibrations or other mechanically induced operations that provide a notification to a user. Further, a cashback notification might include an alert feature, or information associated therewith (e.g., a product or service associated with the cashback offer, a time of presenting the cashback notification, a summary of the cashback offers, or the like). One skilled in the art will appreciate that a cashback notification might be displayed in association with one or more search results corresponding with the search query. That is, a cashback notification might be presented nearby or adjacent to search results that are displayed as a result of a search being performed with respect to the search query. As such, without specifically searching for cashback offers, a user will recognize that such cashback offers associated with the user's search are available while viewing search results requested by the user.

The receiving component 210 functions to receive an indication to provide cashback offers. In one embodiment, the receiving component 210 might receive a user indication to provide cashback offers, such as input from a user indicating the user's interest in viewing a cashback offer. The input may comprise any form of input from any available I/O components 120 of FIG. 1, described above, including, for example a click from a mouse, or a mouse hover, among others. In some cases, a user provides input indicating an interest to view a cashback offer by selecting a cashback notification, such as a notification provided by notifying component 208. In another embodiment, the receiving component 210 might automatically receive an indication to provide cashback offers. For example, an indication to provide cashback offers might automatically be provided upon an occurrence of an event, such as a determination that a cashback offer and/or commercial intent exists, upon a lapse of a time, or the like.

The presenting component 212 presents one or more available cashback offers. In embodiments, the presenting component 212 displays available cashback offers via a computing device, such as a user device. One skilled in the art will appreciate that a display of available cashback offers may be provided in any configuration. For example, the cashback offers might be displayed via a webpage depicting the cashback offers (e.g., a cashback webpage dedicated to providing items associated with cashback offers). In such a case, a cashback webpage displaying cashback offers might be presented to a user in place of the general search results generated by the general search engine initially provided to a user. Alternatively, the cashback offers might be displayed via a window that depicts available cashback offers. Such a window may comprise a new web browser window, or a pop-up window, among others. In presenting an available cashback offer, the cashback offer might be displayed among other items or details associated with the cashback offer, such as information about the offer, links to the offer depicted therein, other search result links, and the like.

In one embodiment, the presenting component 212 might present available cashback offers upon receiving a user indication, such as receipt of an input from a user indicating an interest in viewing a cashback offer. In another embodiment, the presenting component 212 might present available cashback offers automatically. In this regard, the presenting component 212 might present available cashback offers upon the occurrence of an event, such as a determination that a cashback offer and/or commercial intent exists, or upon a lapse of a time, etc.

One skilled in the art will appreciate that not all components discussed herein are necessary for a cashback tool to provide cashback offers. By way of example only, as discussed above, in some cases, a cashback notification might be provided when one of a cashback offer exists or commercial intent exists. In such a case, either the offer determining component 204 or the intent determining component 206 may be unnecessary. In addition, in some cases, cashback offers might be presented upon a determination that such offers exist and/or upon a determination that commercial intent exists. In this regard, rather than displaying a cashback notification for a user to select in order to display available cashback offers, any available cashback offers might be displayed without receiving a user-selection to display. In such a case, the available cashback offers might be displayed in a toolbar or a window presented in association with the search results. For example, upon submitting a search query, any related cashback offers might be presented alongside the search results (e.g., to the right of general search results generated by a general search engine). In such a case, a cashback tool can operate without a notifying component 208 and/or a receiving component 210.

With reference now to FIG. 3, a method 300 for providing a cashback notification is described. Initially, as indicated at block 302, a search query, or a portion thereof, is obtained. Such a search query might be intercepted upon a user submitting the search query to a search engine. In embodiments, obtaining the search query does not interfere with functioning of the search engine. The search query, or search terms associated therewith, are used to determine if one or more cashback offers exist that correspond with the search query, or search terms associated therewith, as depicted at block 304. To determine if a cashback offer exists, the search query or one or more search terms associated therewith might be compared with cashback offers, or information associated therewith, stored within one or more cashback databases. Alternatively, a search of a website having cashback offers might be conducted, as described more fully above.

If it is determined at block 304 that a cashback offer does not exist, the method 300 returns to block 302 to obtain another search query, or a portion thereof. For example, if search terms entered by a user do not correspond with cashback offers listed in a database, then it can be determined that no cashback offers exist. Conversely, if it is determined at block 304 that one or more cashback offers exist, a cashback notification is provided at block 306. For instance, assume that search terms entered by a user correspond with cashback offers listed in a database, then it can be determined that a cashback offer exists. By way of example only, assume that a user enters a search query containing the term “television” and, thereafter, a database of available cashback offers contains offers for one or more televisions, then it may be concluded that one or more cashback offers are available.

After determining that one or more cashback offers exist, a cashback notification is provided to the user at block 306. Such a cashback notification may be of any form as described above (e.g., a visual notification and/or an audio notification). The cashback notification can provide a notification to a user that a cashback offer is available for an item in association with the search query entered by the user.

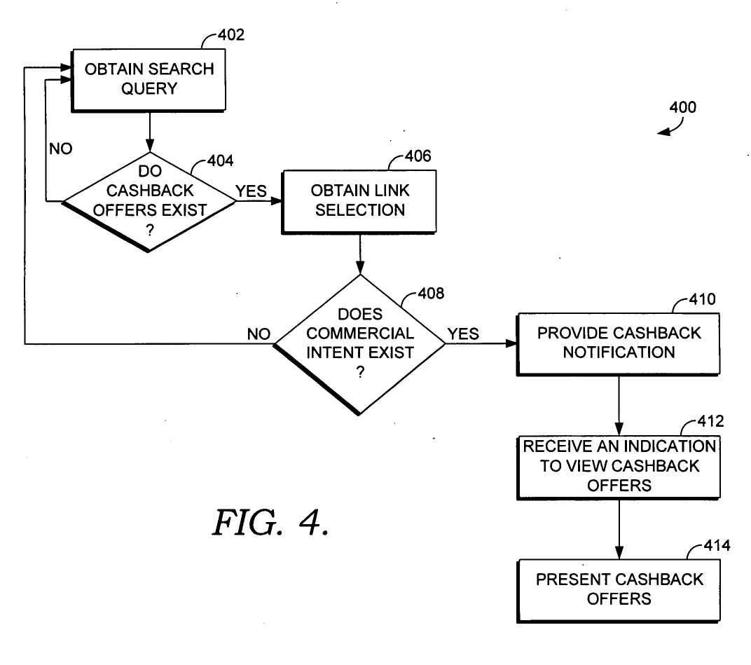

With reference now to FIG. 4, a method 400 for providing one or more cashback offers on a display is described. Initially, as indicated at block 402, a search query, or a portion thereof, is obtained. Such a search query might be intercepted upon a user submitting the search query to a search engine. The search query, or search terms associated therewith, are used to determine if one or more cashback offers exist that correspond with the search query, or search terms associated therewith, as depicted at block 404. To determine if a cashback offer in association with the search query exists, the search query or one or more search terms associated therewith might be compared with one or more cashback databases having available cashback offers. Alternatively, a search of a website having cashback offers might be conducted, as described more fully above.

If it is determined at block 404 that a cashback offer does not exist, the method 400 returns to block 402 to obtain another search query, or a portion thereof. Conversely, if it is determined at block 404 that one or more cashback offers exist, an identity of a link selection is obtained at block 406. In one embodiment, such an identity of a link selection, among other things, might be intercepted upon a user selecting a link presented on a search results webpage.

At block 408, it is determined whether commercial intent exists. That is, it is determined whether the user demonstrates commercial intent. The identify of a link selection and associated information can be used to determine whether commercial intent exists. If it is determined at block 408 that commercial intent does not exist, the method 400 returns to block 402 to obtain a subsequent search query, or a portion thereof. If, however, it is determined at block 408 that commercial intent does exist, a cashback notification is provided to a user via a display screen that indicates a cashback offer is available. Such a cashback notification enables a user to identify a potential for a cashback opportunity and have an option to access or view available cashback offers. Subsequently, at block 412, an indication to present available cashback offers is received. In embodiments, such an indication is automatically provided or user-provided. A user can provide an input via a click of a mouse or any other input, for example, from the I/O component 120 of FIG. 1 to indicate interest in a cashback offer.

Upon receipt of an indication to present available cashback offers, one or more available cashback offers are presented, as indicated at block 414. The available cashback offers might be displayed to a user via a display screen. In such a case, the user may interact with the displayed cashback offers to complete an inquiry, to purchase an item, to receive cashback, or to navigate further.

By way of example only, assume that a user enters a search query for “bears” and search results are provided to a user. Further assume that, upon analysis, it is determined that cashback offers exist for “bears.” In an instance that the user subsequently selects a link for a website presented within the search results where, for example, information on protecting bears from poachers or encyclopedic information on bears generally is provided, then it can be determined that the user does not have commercial intent. That is, because the user demonstrates an interest in searching for information relating to bears and not for bear related products or services, there is no indication that commercial intent exists. In contrast, in an instance that the user subsequently selects a link for a website within the search results that is associated with a retailer of fine teddy bears, then it can be determined that user has commercial intent. As such, a cashback notification can be displayed to the user to provide an indication that cashback offers are available. In instances where the user selects the cashback notification, or otherwise provides an indication of an interest in the available cashback offers, one or more available cashback offers are displayed to the user. Such cashback offers might be displayed, for example, within a webpage or a window.

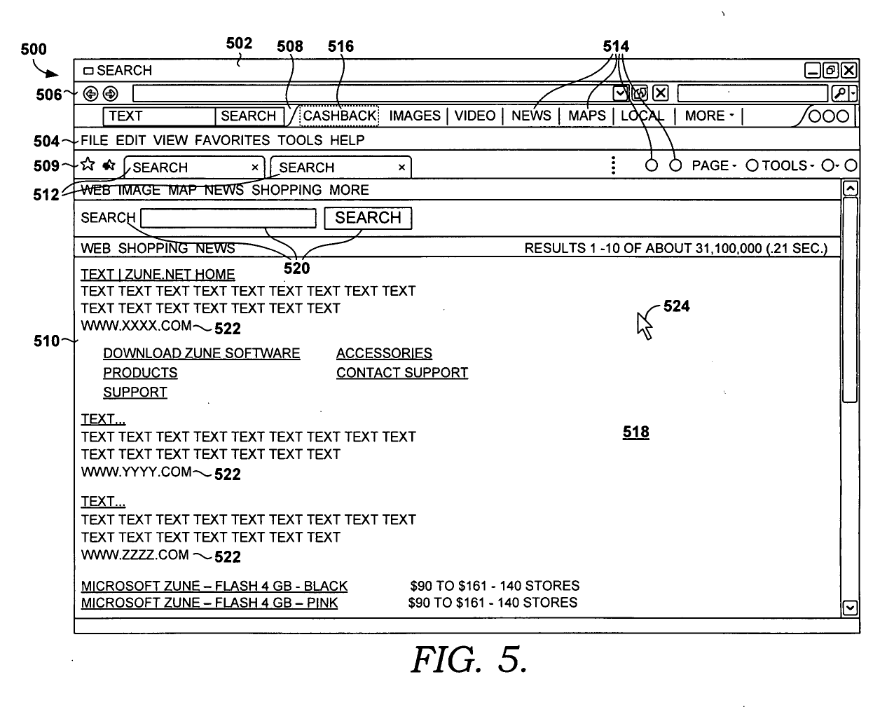

Referring now to FIG. 5, an illustration of a web browser window 500 is described according to an embodiment of the present invention. The web browser window 500 includes a title bar 502, a menu bar 504, a navigation bar 506, one or more toolbars 508 and 509, and a display pane 510. Each of the components 502-510 are generally known in the art and may take various forms and configurations in web browser windows provided by various software providers. One or more of the components 502-510 may be modified or excluded from a web browser window 500 either by design of a software provider or by a preference or customization of the web browser window by a user.

The title bar 502 is generally located near a top portion of the web browser window 500 and may contain text describing the web browser window or a website that is displayed in the display pane 510. The menu bar 504 may contain one or more labels that, when selected, provide one or more drop-down menus having various functions for use by a user. The navigation bar 506 may provide a variety of navigation functions as well as a field for displaying a current web location or for entry of a web location to which navigation is desired.

One or more toolbars 508 and 509 may be provided in the web browser window 500 and may contain tabs 512 for aiding a user in navigating the Web and in organizing display space. The toolbars 508 and 509 may also contain one or more shortcut buttons 514 that provide ease of access to commonly used functions as well as one or more of a multitude of web browser add-on components that are available in the art.

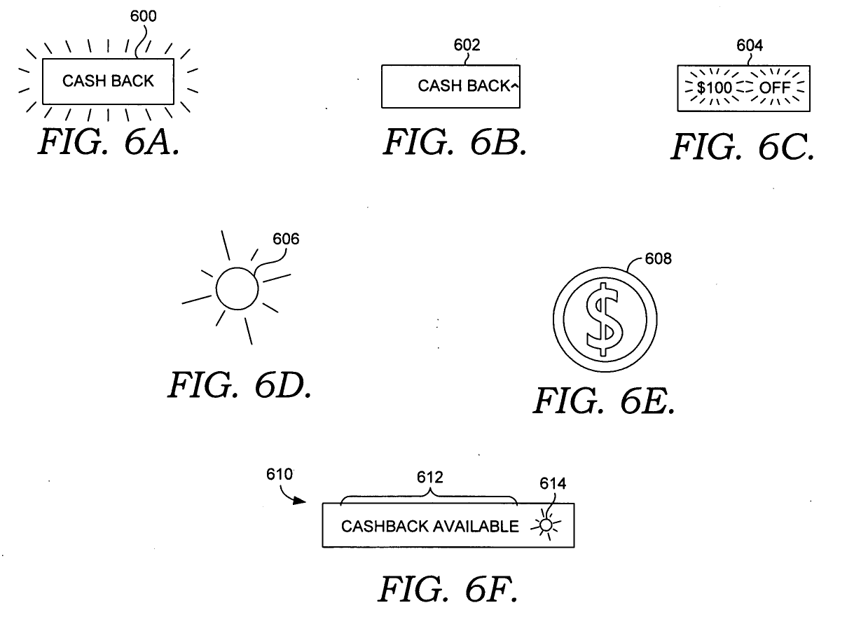

A cashback notification 516 is provided on the toolbar 508 for providing notifications to a user regarding available cashback offers. In embodiments, the cashback notification 516 can also be used to receive input from the user indicating an interest in cashback offers. The cashback notification 516 may take any form capable of providing a notification to a user and, in some cases, receiving input from the user. Separate portions of the cashback notification 516 may be employed in which one portion provides a notification to a user and a separate portion receives user input, or both functions may be provided by a single component. Several illustrative examples of the visual representation of the cashback notification 516 are described below with respect to FIGS. 6A-F, according to embodiments of the present invention.

The cashback notification 516 may be located on the toolbar 508, as depicted in FIG. 5, but may additionally or alternatively be located at any available position in web browser window 500. Further, the cashback notification 516 may be separate from a web browser window, and located elsewhere on a display screen.

With continued reference to FIG. 5, the display pane 510 may display a webpage, such as a search results display 518, as is depicted therein. The search results display 518 may include various search engine display elements 520 such as a search engine title, a search query field, and a search button, among others. The search results display 518 may also include one or more links 522 corresponding to one or more search results. The links 522 may be in the form of a World Wide Web address and may typically be accompanied by text describing, or excerpted from, the webpage to which the links navigate.

A cursor 524 may also be present on a user's display. The cursor 524 allows a user to interact with elements on the display including the cashback notification 516 through use of an I/O component 120 of FIG. 1, such as a mouse.

With additional reference to FIGS. 6A-F, several illustrative examples of a cashback notification are shown. The cashback notification may be embodied as a rectangular button with text thereon stating, for example, “CASHBACK,” as is shown in FIG. 5. In such an embodiment, the cashback notification 516 may flash or change colors when it is determined that a notification should be provided. Additionally, a sound may be provided to further the ability of the interactive component to gain a user's attention.

In another embodiment, a cashback notification 600 may have a generally square shape on which the text, such as, “CASHBACK” appears when one or more cashback offers are available, and the cashback notification can blink when a cashback offer is available, as is depicted in FIG. 6A. In other embodiments, text, such as, “CASHBACK” may scroll across a cashback notification 602 of FIG. 6B, or a text describing a monetary amount of a cashback offer may flash or blink within a cashback notification 604 of FIG. 6C. Yet other embodiments may provide a cashback notification 606 of FIG. 6D as an icon, an orb, or a button that changes color or blinks when a cashback offer is available. Such an icon, orb, or button might have a two-dimensional or three-dimensional appearance. Alternatively, a cashback notification 608 of FIG. 6E comprises an icon or symbol that flashes, illuminates, blinks, or animates to indicate availability of cashback offers. In yet another embodiment, a two-part cashback notification 610 of FIG. 6F may have a text portion 612 that appears when a cashback offer is available and an input portion 614 that blinks upon receiving an input from a user. One of skill in the art will recognize that cashback notifications may be created in a multitude of designs, all of which cannot be described but are incorporated herein.

An illustrative example of an embodiment of the present invention is provided below for providing one or more cashback offers. This example is only provided for illustration of one possible scenario in which the present invention is applied and is in no way intended to limit the scope of the invention as described herein. Assume that a user enters a search query, such as “Zune® media player,” into a search field of a search engine at a user device having a cashback tool installed thereon. The search query is intercepted by the query obtaining component 202. The search terms (e.g., Zune, media, and player) are compared to a database having available cashback offers, or information associated therewith, to determine if a cashback offer in association with the search query exists. For example, it might be determined that a cashback offer exists for a Zune® media player.

In response to a search query entered by the user into the search engine, search results are displayed having links to the websites of various merchants selling products, such as a Zune® media player, as well as other websites providing reviews or other information about media players, such as the Zune® media player. The user may then select one of the links presented within the search results.

Assume that a user selects one of the links presented within the search results. In such a case, the link selection, or information associated therewith is obtained. The link selection is compared to a listing of links associated with commercial intent. Such a listing of links might be located on a network server. The listing of links might contain a list of links associated with numerous merchants that may sell products or services for which cashback offers are available. In cases where the link selected by the user is included within the list of links associated with commercial intent, it is determined that commercial intent of the user exists.

Upon determining that the search terms entered by the user correspond to a product for which a cashback offer exists and that the user has commercial intent, a cashback notification is provided that indicates that a cashback offer is available. The notification is provided to the user via an interactive component located on a toolbar in the user's web browser window. In one embodiment, the cashback notification comprises a rectangular button with the text “CASHBACK” across its length as well as a small cashback icon. The cashback notification flashes to provide a notification to the user that cashback offers are available that might be of interest to the user.

Assume that the user observes the flashing cashback notification and, thereafter, selects or clicks on the interactive component to indicate an interest in the cashback offer. Upon receiving the input of the user selection of the cashback notification, one or more cashback offers that are available and might be of interest to the user are displayed by redirecting the user to a cashback website that provides cashback offers or provides the cashback offers within a window. From the cashback website, the user may browse the available cashback offers and, if desired, purchase the item, such as the Zune® media player. In instances where the user performs the desired incentivised activity, such as purchase of a product, the user receives a reward, such as a monetary reward.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method for providing on a display one or more cashback offers, the method comprising:
obtaining a search query entered by a user into a search engine;
using the search query to determine that one or more cashback offers in association with the search query exist; and
providing a cashback notification that provides an indication that one or more cashback offers are available, wherein the cashback notification is displayed in association with one or more search results corresponding with the search query.

2. The computer-implemented method of claim 1, wherein the search query, or a portion thereof, is compared to a list of one or more cashback offers associated with a plurality of items to determine that the one or more cashback offers in association with the search query exist.

3. The computer-implemented method of claim 2, wherein the list of the one or more cashback offers is stored within a database at a user device or at a server.

4. The computer-implemented method of claim 1, wherein the search query, or a portion thereof, is utilized by a cashback search engine to determine that the one or more cashback offers in association with the search query exist.

5. The computer-implemented method of claim 1, further comprising:
displaying search results associated with the search query, each search result including one or more links;
identifying a link selected by a user or information associated therewith; and
using the selected link to determine that a user has commercial intent, wherein commercial intent exists when the user demonstrates an intent or interest in performing an incentivized activity.

6. The computer-implemented method of claim 5, wherein the search query, or a portion thereof, is compared to the selected link, or the information associated therewith, to determine that the user has commercial intent.

7. The computer-implemented method of claim 5, wherein the selected, or information associated therewith, is compared to a list of links associated with the sale of one or more products or services to determine that the user has commercial intent.

8. The computer-implemented method of claim 1, wherein the cashback notification is provided to the user via a toolbar in a web browser window, the cashback notification comprising one or more of a button, an icon, text, a sound, and an animation.

9. The computer-implemented method of claim 8, wherein the cashback notification on the toolbar provides the notification by one or more of blinking, flashing, changing colors, providing text, providing images or icons, and animating.

10. The computer-implemented method of claim 9, wherein text within the cashback notification describes at least one of the one or more available cashback offers.

11. The computer-implemented method of claim 8, further comprising:
receiving an input from the user via the cashback notification; and
displaying the one or more available cashback offers.

12. A computerized system for providing cashback offers, the system comprising:
a query obtaining component configured to obtain a search query entered into a search engine;
an offer determining component configured to determine that one or more cashback offers in association with the search query exist;
a notifying component configured to provide a cashback notification that provides an indication that one or more cashback offers are available, the cashback notification being displayed in association with one or more search results that correspond with the search query;
a receiving component configured to receive an input from a user indicating a desire to view the one or more available cashback offers; and
a presenting component configured to display the one or more available cashback offers.

13. The computerized system of claim 12, wherein the offer determining component determines that the one or more cashback offers exist by comparing the search query, or a portion thereof, with a list of one or more cashback offers, wherein the list of the one or more cashback offers is stored within a database at a user device or at a server.

14. The computerized system of claim 12, wherein the offer determining component determines if the one or more cashback offers exist by utilizing the search query, or a portion thereof, via a cashback search engine to determine that the one or more cashback offers in association with the search query exist.

15. The computerized system of claim 12, further comprising:
an intent determining component configured to determine that the user has commercial intent that exists when the user demonstrates an intent or interest in performing an incentivized activity, wherein the notifying component provides the cashback notification when the offer determining component determines that the one or more cashback offers in association with the search query exists and the intent determining component determines that the user has commercial intent.

16. The computerized system of claim 15, wherein the intent determining component determines that the user has commercial intent by one or more of comparing the search query, or a portion thereof, with information associated with a link selected by the user from among a plurality of links displayed as a result of a search corresponding with the search query and comparing information associated with the link selected by the user with a database of links stored on a user device or on a server.

17. The computerized system of claim 12, wherein the notifying component is displayed to the user via a toolbar on a web browser window, wherein the notifying component provides the cashback notification to the user by one or more of blinking, flashing, changing colors, providing text, providing images or icons, and animating.

18. The computerized system of claim 12, wherein the user provides the input to the receiving component by selecting a visual element on a display.

19. The computerized system of claim 12, wherein the one or more available cashback offers are displayed via a cashback website.

20. One or more computer readable media having computer-executable instructions embodied thereon, that when executed, perform a method for providing cashback offers, the method comprising:
obtaining a search query at a search engine that provides both cashback search results and non-cashback search results via a search results webpage;
determining that one or more cashback offers in association with the search query exist by comparing one or more search query terms of the search query with a set of cashback offers or information associated therewith;
obtaining the identity of a link selected by a user, the link being displayed on the search results webpage;
determining that the user has a commercial intent by comparing the one or more search query terms with the identity of the selected link or information associated therewith;
displaying a cashback notification to the user via a toolbar upon the determination that the one or more cashback offers in association with the search query exist and the determination that the user has commercial intent, wherein the cashback notification provides an indication that one or more cashback offers are available;
receiving a user-selection of the cashback notification; and
presenting the one or more available cashback offers on a display.
